(19) United States
(12) Patent Application Publication
(10) Pub. No.: US 2023/0330623 A1
(43) Pub. Date: Oct. 19, 2023

(54) SORBENT MIXTURES TO REMOVE HEAVY METALS FROM WATER

(71) Applicant: Aquaguidance Technologies, Ltd., Nassau, New Province (BS)

(72) Inventors: Andrew Lombardo, Pompano Beach, FL (US); Symon Thomas, Leven (GB); Denisse Gisella Valentin, North Miami Beach, FL (US); Jonathan Andrew Hardie, Fort Lauderdale, FL (US); Michael Warren Hall, Royal Palm Beach, FL (US)

(73) Assignee: Aquaguidance Technologies, Ltd., Nassau (BS)

(21) Appl. No.: 18/026,094

(22) PCT Filed: Apr. 5, 2022
(86) PCT No.: PCT/US22/23516

§ 371 Date: Mar. 13, 2023

Related U.S. Application Data
(60) Provisional application No. 63/174,806, filed on Apr. 14, 2021.

(51) Int. Cl. B01J 20/16; B01J 20/04; B01J 20/02; B01J 20/06; B01J 20/12; B01J 20/28; C02F 1/28

(52) U.S. Cl. CPC B01J 20/165; B01J 20/043; B01J 20/0211; B01J 20/0281; B01J 20/048; B01J 20/06; B01J 20/12; B01J 20/28016; C02F 1/288; C02F 1/281; C02F 2101/20

(57) ABSTRACT

Disclosed is a heavy metal adsorbing mixture that sequesters heavy metals such as lead from water. The mixture is formed from two of more lead sorbents. The lead sorbents exhibit a synergistic effect such that the lead adsorption of the mixture of materials is greater than the theoretical maximum absorption of the individual components of the mixture. Mixtures of lead sorbents that exhibit synergistic lead adsorption are characterized by elemental compositions within specified ranges by weight, as measured by x-ray fluorescence.

### BACKGROUND

### Field

The present disclosure relates to materials that sequester contaminants from water. In particular, the present disclosure is directed to sorbents that sequester lead or other heavy metals from water and to combinations of sorbent materials that exhibit a synergistic ability to sequester lead greater than the ability of individual components of the combinations to sequester lead. More particularly, the present disclosure is directed to combinations of materials with a synergistic ability to sequester lead from water that are characterized by concentrations of certain elements as determined by X-ray fluorescence analysis.

### Description of the Related Art

Lead is a dangerous contaminant of drinking water. Various lead adsorbing materials are known that can sequester lead ions dissolved in water. Known lead sorbents may not have a sufficient ability to sequester lead to reduce the lead concentration to safe levels for consumption.

Certain lead sorbents may be expensive to manufacture. Known sorbents that are relatively inexpensive may have a limited ability to sequester dissolved lead. It would be an improvement in the art to provide improved lead removal from water using relatively less expensive lead sorbents to sequester lead. It is also known that some materials that adsorb lead also leach ions that are themselves harmful for human consumption. For example, some minerals known to adsorb lead also leach contaminants such as arsenic and selenium. It would be an advantage over the prior art to provide combinations of materials that sequester lead ions from water that are more effective than individual known lead sorbents where those combinations of materials do not leach other harmful materials.

It would also be an improvement over the known art to identify combinations of lead sorbent materials that exhibit synergistic effect in sequestering lead based on elemental concentrations.

Water filtration serves a variety of needs, including providing potable water for home or institutional consumption, delivering large quantities of water to municipal water systems, and providing purified water for industrial processes. Filters designed to service these needs may have a wide variety of geometries and may filter water at various flow rates, at different flow velocities, and under circumstances that influence the contact time between water and the active components of the filter media. Typical a single lead sorbent material is selected from a limited range of commercial sorbents to form the filter element. It would be an improvement over the know art to identify combinations of sorbents that work together synergistically that can be used for different applications. It would be a further improvement to provide combinations of lead sorbents that exhibit a desired degree of lead adsorption but where a reduced amount of a more expensive component can be used.

### SUMMARY

The present disclosure relates to combinations of lead adsorbing materials that exhibit an improved capacity to sequester lead.

A surprising result of combinations of lead adsorbents according to embodiments of the disclosure is that the combination of materials, each material known to sequester dissolved lead from water has a greater ability to adsorb lead that would be expected based on the lead adsorption of the individual components.

Another surprising result of lead sorbents according to embodiments of the disclosure is that combinations of lead adsorbing materials that have an improved ability to sequester lead above what would be expected based on the lead adsorption of the individual components can potentially be characterized by determination of elemental concentrations. According to embodiments of the disclosure, ranges of elemental composition are shown to identify combinations of lead sorbents that exhibit synergistic lead adsorption and to distinguish combinations which do not exhibit synergistic lead adsorption. Such elemental combinations can be determined by known elemental analysis techniques. According to embodiments of the disclosure, the elemental compositions of synergistic combinations of lead sorbents are characterized by x-ray fluorescence.

According to other embodiments of the disclosure, combinations of lead sorbents are provided that demonstrate greater efficacy in sequestering lead from water that the efficacy of the components individually. According to some embodiments, selected combinations of lead sorbents that synergistically sequester lead from water are selected to provide a desired sequestering ability at a reduced cost.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a graph showing percent lead reduction for a range of mixtures of sorbents that exhibit synergistic lead adsorption;

FIG. 1B is a graph showing lead reduction in parts-per-billion for the range of mixtures of sorbents in FIG. 1A;

FIG. 1C is a graph showing percent synergy for the range of mixtures of sorbents in FIG. 1A;

FIG. 2A is a graph showing percent lead reduction for a range of mixtures of sorbents that exhibit interfering lead adsorption;

FIG. 2B is a graph showing lead reduction in parts-per-billion for the range of mixtures of sorbents in FIG. 2A; and

FIG. 2C is a graph showing percent interference for the range of mixtures of sorbents in FIG. 2A.

### DETAILED DESCRIPTION

Various materials are known to be able to sequester lead from water. In some applications such materials are used as a free-flowing powder that is brought into contact with water to be treated. The powder is allowed to contact the water, including dissolved lead, for a period of time. When the water is separated from the material, a portion of the dissolved lead remains adsorbed by the material, with the effluent water having a reduced lead concentration.

In other applications, a lead adsorbing material is incorporated into a solid, porous block. In some embodiments, forming filter materials into a solid structure helps maintain pathways for fluid flow and prevents smaller particle size adsorbents from compacting. In some embodiments, forming filter material into a porous solid reduces the pore size between filter particles, thereby reducing the diffusion distance for lead ions to be adsorbed from solution onto the particles. Influent water containing a concentration of dissolved lead is passed through the porous block. As the water interacts with the material, a portion of the dissolved lead is sequestered in the material. Effluent water flowing out of the block has a reduced lead concentration. In either case, chemical and physical interaction between the lead adsorbing material and dissolved lead ions causes the lead ions to remain connected with the adsorbent material.

Materials known to adsorb lead ions dissolved in water include zeolites, molecular sieves, and oxides, hydroxides, oxyhydroxides, phosphates, silicates, and carbonates of a metal. For example, many commercially lead adsorbents are oxides or silicates of titanium. The manufacturing process to create titanium-based sorbent may be expensive. Embodiments of the disclosure include combinations of such materials that provide synergistic adsorption of lead and other heavy metals that potentially provide a lower cost material for water filtration.

Several mechanisms have been proposed for the sequestering of lead ions and other heavy metal ions by sorbents. These include ion exchange where species of the same hydrated valency can ‘exchange’ between ionic relationships, driven by the equilibrium pressures of relative concentration vs limits of solubility. For example, divalent lead ions Pb′ in solution are exchanged for Ca²⁺ or Mg²⁺ ions in the lattice of the sorbent.

K M²⁺_{(aq)}+Wₓ(Z)_{y(s)}→K W²⁺_{(aq)}Wₓ₋ₖMₖ(Z)_{y(s)},
Where,
K, x, y—integer, for molar balance,
M—Contaminant Metal (divalent in aqueous solution) e.g., Pb, Zn, Cu,
W—Adsorbent Counter ion—Calcium or Magnesium, and
Z—Carbonate (CO₃)²⁻, Phosphate (PO₄)³⁻ or Zeolite—containing (AlO₄)⁵⁻ and (SiO₄)⁴⁻

In addition, lead or other heavy metal contaminants can be incorporated into the crystal lattice of a sorbent by chemisorption by substituting for similar ionic sized species of the same ionic valency.

K M²⁺_{(aq)}+Wₓ(Z)_{y}(OH)_{w(s)}→K H⁺_{(aq)}+Mₓ(Z)_{y}(OH)_{w-k}(OW⁺)ₖ₍ₛ₎

Another mechanism where heavy metals are sequestered onto the sorbent is by precipitation, where reactive groups, such as OH⁻, are generated at the surface of the sorbent that react with contaminant ions and precipitate out of solution and onto the sorbent. Such a mechanism may be characterized by the flowing reactions:

Dissolution (surface localized):

W₁₀(Z)₆OH₂+14H⁺→10W²⁺+6H₂(Z)⁻+2H₂O

### Precipitation:

xM²⁺+10W²⁺+6H₂(Z)−+2H₂O→W₁₀₋ₓMₓ(Z)₆OH₂+ₓW²⁺+14H⁺

Precipitation can also occur under localized increased pH due to dissolution of OH⁻

xM²⁺_{(aq)}+2(OH⁻)_{(aq)}→xM(OH)ₓ₂₍ₛ₎

Where the hydroxide can be derived from the reaction of a suitable solid oxide

WO₍ₛ₎+H₂O_{(aq)}→W(OH)_{2(aq)}

While the precise mechanism for our observed synergistic uptake of lead has not been fully determined, multiple methods and mechanisms for lead sorption are well understood in the literature. Not wishing to be bound by theory, it is proposed that, by combining lead sorbents where synergy is observed, the two components operate by different pathways—these may be complimentary or entirely independent, but the sum is greater than the two parts. Where no synergy is observed, it is likely that the same mechanism of sorption is being employed by the two components and where interference occurs it is likely that the components operate using competing mechanisms.

The ability of these materials to sequester lead from water is referred to herein as the lead adsorption of the material. Lead adsorption may be characterized at a percentage change in the concentration of dissolved lead ions from influent water to effluent water. One technique for determining lead adsorption of a material is to form the material as a powder, to mix the powder with water containing a known concentration of lead, to allow the material to contact the water for a selected length of time, to filter the powdered material out of the water, and then to measure the concentration of lead remaining in the water after contact with the material. As discussed below, lead adsorption of a number of lead sorbent materials were measured using this technique.

According to embodiments of the disclosure, combinations of certain known lead adsorbing materials provide an improved ability to adsorb dissolved lead, as compared with the lead adsorption performance of the individual materials. Embodiments according to the disclosure show that selected combinations of lead absorbents exhibit a synergistic effect over and above what would be expected based on the lead adsorption of individual components. Other combinations of lead adsorbing materials have lead adsorption lower than would be expected based on the lead adsorbing performance of the individual components. These combinations of materials interfere with one another so that the combination has a reduced ability to sequester dissolved lead.

There are known standard tests for evaluating the effectiveness of lead sorbents to sequester dissolved lead ions. One such test developed by NSF-International for determining the reduction of certain health related contaminants in water is NSF/ANSI 53. For purposes of quantifying lead adsorption for combinations of materials, as according to embodiments of the present disclosure, a test such as the lead reduction testing protocols of NSF/ANSI 53 may be impractical. NSF/ANSI 53 requires effluent samples to be collected over a period of days or weeks. Protocols described in the present disclosure can identify synergistic or interfering combinations of materials more rapidly than the NSF/ANSI 53 test.

A protocol was developed to identify combinations of materials that acted synergistically, according to embodiments of the disclosure, to sequester dissolved lead from water. Reagents, concentrations, and method used in this protocol are based on the methods set forth in NSF/ANSI 53.

First, a set of test reagents was prepared. An acid solution was prepared by diluting 100 ml of 37% HCl in 900 ml of reverse osmosis purified, deionized (RO/DI) water to create approximately 1 liter of a 3.7% hydrochloric acid solution. A sodium bicarbonate solution was prepared by dissolving 66 grams of sodium bicarbonate (NaHCO₃) in 1000 ml RO/DI water. A calcium solution was prepared by dissolving 70.00 grams of calcium chloride hexahydrate (CaCl₂x6H₂O) in 1000 ml of RO/DI water. A magnesium sulfate solution was prepared by dissolving 65.53 grams of magnesium sulfate heptahydrate (MgSO₄x7xH₂O) in 1000 ml RO/DI water.

A quantity of batch water was prepared by mixing 12.6 ml of the sodium bicarbonate solution, 10.0 ml of the calcium solution, and 10.0 ml of the magnesium solution with 19 liters of RO/DI water. Hydrochloric acid solution was added drop-by-drop to adjust the pH of the solution to about 6.5 (+/−0.25).

A lead reagent solution with a known concentration of dissolved lead was prepared. According to one embodiment, the lead reagent solution had 30 parts per million of lead ion dissolved in water. This concentration was selected so that, when used in the protocol described below, a 50 ml addition of the lead reagent solution would result in a 750 parts per billion (ppb) concentration of lead in 2 liters of water. The lead reagent solution was prepared by first creating a presolution by dissolving 3.60 grams of lead (II) nitrate (Pb(NO₃)₂) in 1000 ml of 1% nitric acid. The lead reagent solution was then prepared by mixing 13.320 ml of the pre-solution with 1000 ml of 1% nitric acid to provide a final lead concentration of 30 ppm.

To test the concentration of the lead reagent solution, a 2-liter Erlenmeyer flask was filled with 1950 ml of batch water. 50 ml of the lead reagent solution was added to the flask in 10 ml increments at selected points in time, as described below. The flask was stirred with a magnetic stirrer for 30 seconds and a sample as withdrawn from the flask. The sample was tested to confirm that the final lead concentration is 750 parts per billion (ppb) after 5 additions. The amount of lead (II) nitrate in the lead reagent solution was adjusted to achieve a 750 ppb lead concentration when 50 ml of the lead reagent solution is mixed into 1950 ml of batch water.

For each test run, a comparison of one lead sorbent materials alone and in combination with one or more other lead sorbent materials were conducted.

### Two-Material Comparison Protocol

According to one embodiment, combinations of two lead adsorbing materials, as compared with the absorption of the materials individually was determined as follows.

The materials are identified here generically as material #1 and material #2. Experimental runs were performed using selected pairs of materials.

According to a method within the scope of the disclosure, three test samples were prepared for each test run. Sample #1 consisted of 0.5 grams of material #1. Sample #2 consisted of 0.5 grams of material #2. Sample #3 consisted of 0.5 grams of material #1 mixed with 0.5 grams of material #2.

Four 2-liter Erlenmeyer flasks were each provided with 1900 ml of batch water, prepared as described above. These were identified as Flask #1, Flask #2, Flask #3, Flask #4. Samples #1-#3 were added, respectively, to Flasks #1-#3. No material was added to Flask #4. Flask #4 provided a control case, showing lead concentration without treatment.

Flasks #1-#4 were each set on respective magnetic stirring stages and a stirring bar was placed in each flask. Each flask was stirred continuously throughout the test. A pH meter was calibrated and used to measure the pH of each flask after the addition of the sample. For each flask, the pH probe was immersed in the flask. Drops of hydrochloric acid solution, as prepared above, were added until the pH measured about 6.5 (+/−0.25). Once pH adjustment was complete for the flask, approximately 50 ml of batch water was poured over the pH probe to wash any material clinging to the probe from the probe and into the flask. The same pH adjustment procedure was done to Flask #4. At the end of this procedure, each flask contained approximately 1950 ml of solution.

An auto-pipettor was filled with a quantity of the lead reagent solution, as prepared above. The auto-pipettor was adjusted to deliver 10 ml quantities of solution. Lead solution was added to each of Flasks #1-#4 as follows. A first dose of 10 ml of lead solution was added at time 0, as measured by a stopwatch. Subsequent 10-ml doses of lead solution were added at 6 minutes, 12 minutes, 18 minutes, and 24 minutes so that a total of 50 ml of lead solution was added to each flask, bringing the contents of each flask to approximately 2000 ml. At 24.5 minutes after the first addition of lead solution, a syringe was used to collect a 10 ml sample from each of Flasks #1-#4.

Each 10 ml sample was filtered through a 0.45-micron syringe filter and placed in a labeled centrifuge tube. The samples were stabilized by adding 8 drops of 70% nitric acid to each sample to avoid precipitation of lead in solution. Precipitated particles could result in an inaccurate analysis of lead concentration. The samples were analyzed to determine lead concentration using a known technique for elemental analysis such as microwave plasma atomic emission spectroscopy (MP-AES) or inductively coupled plasma mass spectroscopy (ICP-MS). According to the embodiments described below, elemental analysis was performed using 1VIP-AES. Lead adsorption for materials #1 and #2 alone is determined from the samples from Flasks #1 and #2. Lead adsorption for the combination of materials is determined from the sample from Flask #3. The result from Flask #4 provided a value for lead concentration without any lead adsorption.

### Three—Material Comparison Protocol

According to another embodiment of the disclosure, to more quickly measure lead adsorption for combinations of materials, testing may be conducted simultaneously for multiple materials and mixes. According to one embodiment, three materials, designated generically as materials #1, #2, and #3 are tested to compare lead adsorption of combinations of materials #1 and #2 and materials #1 and #3 with the adsorption of the materials individually

According to this embodiment, the materials are identified generically as material #1, material #2, and material #3.

Five test samples of materials were prepared for each test run. Sample #1 consisted of 0.5 grams of material #1. Sample #2 consisted of 0.5 grams of material #2. Sample #3 consisted of 0.5 grams of material #3. Sample #4 consisted of 0.5 grams of material #1 mixed with 0.5 grams of material #2. Sample #5 consisted of 0.5 grams of material #1 mixed with 0.5 grams of material #3.

Six 2-liter Erlenmeyer flasks were each provided with 1900 ml of batch water, prepared as described above. These were identified as Flask #1, Flask #2, Flask #3, Flask #4, Flask #5, and Flask #6. Samples #1-#5 were added, respectively, to Flasks #1-#5. No material was added to Flask #6. Flask #6 provided a control case, showing lead concentrations without treatment.

Flasks #1-#6 were each set on respective magnetic stirring stages and a stirring bar was placed in each flask. Each flask was stirred continuously throughout the test. A pH meter was calibrated and used to measure the pH of each flask after the addition of the sample. For each flask, the pH probe was immersed in the flask. Drops of hydrochloric acid solution, as prepared above, were added until the pH measured about 6.5 (+/−0.25). Once pH adjustment was complete for the flask, approximately 50 ml of batch water was poured over the pH probe to wash any material clinging to the probe from the probe and into the flask. The same pH adjustment procedure was done to Flask #6. At the end of this procedure, each flask contained approximately 1950 ml of solution.

An auto-pipettor was filled with a quantity of the lead solution, as prepared above. The auto-pipettor was adjusted to deliver 10 ml quantities of solution. Lead solution was added to each of Flasks #1-#6 as follows. A first dose of 10 ml of lead solution was added at time 0, as measured by a stopwatch. Subsequent 10-ml doses of lead solution were added at 6 minutes, 12 minutes, 18 minutes, and 24 minutes so that a total of 50 ml of lead solution was added to each flask, bringing the contents of each flask to approximately 2000 ml. At 24.5 minutes after the first addition of lead solution, a syringe was used to collect a 10 ml sample from each of Flasks #1-#6.

As in the previous embodiment, each 10 ml sample was filtered through a 0.45-micron syringe filter and placed in a labeled centrifuge tube. The samples were stabilized by adding 8 drops of 70% nitric acid. Elemental analysis was performed on each sample using WIP-AES to determine lead concentration.

According to further embodiments of the disclosure, the test protocol can be expanded to simultaneously test multiple combinations of a lead sorbents. According to one embodiment, both material #1 and material #2 can be tested in combination with a third material #3 using seven flasks. In this embodiment Flask #1 is charged with material #1, Flask 2 is charged with material #2, Flask #3 is charged with material #3, Flask 4 is charged with a combination of materials #1 and material #2, Flask #5 is charged with material #1 and material #3 and Flask 6 is charged with materials #2 and material #3. Flask #7 is untreated, to provide a control value for untreated water. A greater number of materials and material combination can be selected as required by expanding the number of flasks used.

### Calculation of Lead Reduction

The ability for lead sorbent materials and combinations of those materials to adsorb lead was determined as follows.

The Percent Lead Remaining (PLR(x)) for individual material x is determined as

PLR(x)=(M(x)_{E}/B_{E}), (1)
Where, M(x)E is the lead concentration of effluent treated with material x and B_{E} is the lead concentration of the untreated effluent.

For mixtures of adsorbent materials, it is expected that, in the absence of any synergistic or interfering effect, the amount of lead remaining in the effluent will depend on a product of the percent lead remaining for each individual material in the mixture. That is, if the effluent were treated first with material x, the amount of lead remaining would be PLR(x) from Equation 1 above. If the effluent from that first treatment were next treated using material y, the amount of lead remaining would be PLR(x) times the percent lead remaining when treated using material y, that is, PLR(y). The amount of lead remaining can instead be expressed as a theoretical lead adsorption TLAₘᵢₓ(x,y) determined as:

TLAₘᵢₓ(x,y)=1−((B_{E}*(PLR(x)*PLR(y)))/B_{E}), (2)
Where, PLR(x) is the percent lead remaining for material x, PLR(y) is the percent lead remaining for material y, and B_{E} is the lead concentration of the untreated effluent. Note that in this equation B_{E} cancels. B_{E} is included here to show that the term B_{E}*(PLR(x) * PLR(y) is the actual lead reduction (in ppb), which converts to a percentage when divided by B_{E}.

It is expected that sorbent materials show better percent reductions of lead concentration at higher initial concentrations. Thus, TLAₘᵢₓ(x,y) as calculated above should overestimate the combined effect of the two materials to sequester lead.

The percentage of lead actually adsorbed from water treated with a mixture of materials x and y, Actual Lead Absorption ALAₘᵢₓ(x,y) is computed as follows:

ALAₘᵢₓ(x,y)=(B_{E}−M(x,y)E)/B_{E}, (3)

Where, M(x,y)E is the lead concentration of effluent treated with the combination of material x and material y, and B_{E} is the lead concentration of the untreated effluent.

A metric of synergy or interference exhibited by a mixture of materials x and y, S/Iₘᵢₓ(x,y) for such combinations can be computed as follows:

S/Iₘᵢₓ(x,y)=ALA(x,y)−TLAₘᵢₓ(x,y), (4)
where ALAₘᵢₓ(x,y) is the actual lead adsorption of a mixture of materials from equation (3) and TLAₘᵢₓ(x,y) is the theoretical lead reduction from equation (2).

### EXAMPLE 1

A test run was made comparing lead adsorption of granular calcium carbonate (CaCO₃) SKU #V01052021 manufactured by Pure Supplements Co. alone and combined with chabazite, a commercially available zeolite, Product No. AZLB-Na Chabazite, manufactured by St Cloud Mining Co. (referred to herein as #7 chabazite). The materials were size characterized using a Horiba Partica LA-960 particle size analyzer. The granular Calcium Carbonate had a particle size distribution of D(10) 2.2506 microns (μall); D(25) 3.3574 μm; D(50) 4.8422 μm; D(75) 6.6410 μm; D(90) 8.6623 μm. The #7 chabazite had a particle size distribution of D(10) 6.4104 microns (μm); D(25)11.9384 μm; D(50) 22.8970 μm; D(75) 39.1872 μm; D(90) 57.0439 μm.

The test results were as follows. Lead concentration for effluent treated with calcium carbonate was 749.4 ppb; for #7 chabazite 394.54 ppb; for the combined calcium carbonate and #7 chabazite 83.44 ppb; and for the untreated effluent 792.97 ppb.

The Percent Lead Remaining, PLR(x) of the individual materials was computed using equation (1):

PLR(CaCO₃)=(749.4/792.67)=0.95(or 95%)

PLR(#7 Chabazite)=(394.54/792.67)=0.50(or 50%)

The Theoretical Lead Adsorption (TLAₘᵢₓ) was computed using equation (2):

TLAₘᵢₓ(CaCO₃+#7Chabazite)=1−792.27(0.95*0.50)/792.27=52.5%

The Actual Lead Adsorption ALAₘᵢₓ was computed using equation (3):

ALAₘᵢₓ(CaCO₃+#7Chabazite)=(792.67−83.44)/792.67=89.5%

Using equation (4), the synergy/interference metric S/Iₘᵢₓ was calculated as 89.5%-52.5%=37% for the combination of calcium carbonate and #7 Chabazite. The results show that the combination of these materials result in a synergistic improvement in lead absorption above what would be expected for the materials individually.

### EXAMPLE 2

A test run was made comparing lead adsorption of a commercially available lead sorbent, powdered ATS, combined with #7 chabazite, as discussed in Example 1. The ATS material, that is, ammonium-titanyl-sulfate (NH₄)₂TiO(SO₄)₂ was Product No. BF-7012, manufactured by Surfatas, Inc. The chabazite material is the same #7 chabazite as in Example 1. The ATS material had a particle size distribution of D(10) 13.3201 μm; D(25) 22.7202 μm; D(50) 31.8109 μm; D(75) 42.1550 μm; D(90) 53.8892 μm.

A test was conducted as outlined above to compare the actual and theoretical lead reduction of these materials individually and in combination. Lead concentration for effluent treated with ATS was 488.3 ppb; for #7 chabazite 263.14 ppb; for the combined ATS and #7 chabazite 291.57 ppb and for the untreated effluent 817.27 ppb.

The Percent Lead Remaining PLR(x) of the individual materials was computed using equation (1):

PLR(ATS)=488.3/817.27=0.60=60%

PLR(#7 Chabazite)=263.14/817.27=0.32=32%

The Theoretical Lead Adsorption for the mixture of these materials TLAₘᵢₓ is calculated using equation (3):

TLAₘᵢₓ(ATS+#7Chabazite)=(1−(817.27(0.60)*(0.32))/B_{E}=81%

The Actual Lead Adsorption for the mixture ALAₘᵢₓ was computed using equation (3):

ALAₘᵢₓ(CaCO₃+#7 Chabazite)=(817.27−291.57)/817.27=64%

Using equation (4), the synergy/interference metric S/Iₘᵢₓ was calculated as 64%-81%=−17% for the combination of ATS and #7 Chabazite. The results show that the combination of these materials interfere so that the combination of these materials is less effective that would be expected based on the lead adsorption of the materials individually.

### EXAMPLE 3

A test was conducted to determine the bounds of what could be considered a synergistic or interfering effect of combinations of materials, as distinguished from variations due to experimental error. Instead of comparing lead adsorption of two different materials, a single material was used. It is assumed that a comparison of lead adsorption of a material with itself should show no synergy or interference and instead, any differences should be due only to experimental error.

Two experimental runs were performed using ATS and #7 chabazite comparing the lead adsorption of 0.5 grams of the material with 1.0 grams of the same material (i.e., a “mixture” of two 0.5-gram (g) samples). For these tests, five flasks were filled with 1950 ml of batch water, set on magnetic stirring plates, and adjusted for pH, as described in the protocols above. Four of the flasks were charged with lead sorbent material as follows 0.5 g ATS; 1 g ATS; 0.5 g #7 Chabazite; and 1 g #7 Chabazite. The fifth flask was untreated to provide a sample of untreated effluent. Lead solution was added according to the protocols discussed above and samples were collected and tested for lead concentration. The test was performed two times. Table 1.1 shows the results.

TABLE 1.1
Lead Effluent Concentration, Adsorption and Synergy for Same Material

| | | Pb (ppb) | PLR | Pb (ppb) | | | |
|---|---|---|---|---|---|---|---|
| | Pb (ppb) | 0.5 g | 0.5 g | 1.0 g | | | |
| Material | Untreated | Material | Material | Material | TLAₘᵢₓ | ALAₘᵢₓ | S/Iₘᵢₓ |
| ATS | 778.34 | 479.48 | 62% | 323.73 | 62% | 58% | −4% |
| ATS | 712.34 | 480.18 | 67% | 324.7 | 55% | 54% | 0% |
| #7 Chabazite | 778.34 | 412.69 | 53% | 203.31 | 72% | 74% | 2% |
| #7 Chabazite | 712.34 | 409.47 | 57% | 198.09 | 67% | 72% | 5% |

The results above show that when the same material for material #1 and material #2 are used, the S/Iₘᵢₓ ranged between −4% and 5%. According to embodiments of the disclosure, it was assumed that any mix of materials that showed an S/Iₘᵢₓ percentage greater than 5% was considered to synergistically improved the lead adsorption above the theoretical maximum. Any S/Iₘᵢₓ that was less than −5% showed that the mixture of materials interfered, decreasing the total percent adsorbed less than the theoretical maximum.

Tests were performed using a range of lead adsorbent materials. Table 1.2 identifies the materials, the tradename and source, chemical composition, and particle size distribution. As with the embodiments discussed above, particle size distribution was measured using a Horiba Partica LA-960 Particle Size Analyzer.

TABLE 1.2
Lead Sorbent Materials

| | | Part | Primary | | | | | |
|---|---|---|---|---|---|---|---|---|
| Name [symbol] | Supplier [symbol] | Number [symbol] | Component [symbol] | D10 [symbol] | D25 [symbol] | D50 [symbol] | D75 [symbol] | D90 [symbol] |
| ATS | [symbol] Inc | BF-7012 | Titanium Silicate | 13.3201 | 22.7202 | 31.8109 | 42.1550 | 53.8092 |
| Bayoxide [symbol] | [symbol] | E33/E216 | Iron Oxide | 2.1070 | 3.2616 | 4.7314 | 6.6284 | 8.6824 |
| CaCO3 | Pure Supplements | V01052021 | Calcium Carbonate | 2.2506 | 3.3574 | 4.8422 | 5.6410 | 8.6623 |
| MgCO3 | Bulk Supplements.com | [symbol] 035 | Magnesium Carbonate | 38.0013 | 46.8384 | 63.4034 | 33.4131 | 507.8982 |
| Metsorb STP | Graver Technologies | Metsorb STP | Titanium Silicate | 12.1876 | 18.8392 | 29.8454 | 46.9758 | 70.5719 |
| HMRP 50 | Graver Technologies | Metsorb HMRP | Titanium Dioxide | 15.5673 | 35.6317 | 60.2067 | 95.7607 | 184.1800 |
| #5 coarse NV NA | St Cloud Mining | NA | Clinoptillolite (Na) | 9.3932 | 15.8987 | 25.7506 | 39.8645 | 36.9120 |
| # [symbol] coarse JW EM | St Cloud Mining | NA | Clinoptillolite (Ca) | 7.8722 | 13.6342 | 22.7653 | 41.2148 | 70.0780 |
| #7 chabazite | St Cloud Mining | #7 Chabazite | Chabazite | 6.4104 | 11.9184 | 22.8970 | 39.1373 | 57.0429 |
| Calcium Phosphate | Aquaguidance | CCP | CCP | 8.3244 | 12.8717 | 23.9661 | 43.3238 | 64.8428 |
| Fullers Earth Clay | Mountain Rose | 97402 | Fullers Earth | 7.9235 | 13.4922 | 27.4493 | 47.3948 | 57.9857 |
| | Herbs.com | | | | | | | |
| Metsorb STP H | Graver Technologies | Metsorb STP [symbol] | Titanium Silicate | 10.4745 | 18.8776 | 28.7253 | 47.6202 | 72.4187 |
| Zeolite B | [symbol] | Zeolite B | Clinoptilolite | 4.0524 | 8.2087 | 14.7104 | 28.3226 | 53.8719 |
| Dynamic-Dyna | Dynamic Adsorbents Inc | 07078- [symbol] | Activated Alumina | 353.6082 | 738.3618 | 934.7228 | 2186.7941 | 1484.2848 |
| Aqua 07078A | | | | | | | | |
| Alusil | Selecto Scientific | Alusil NanoZinc | Alumina Silicate | 7.8445 | 12.8524 | 31.5382 | 54.1977 | 74.3128 |
| | | 700 | | | | | | |
| Gordes Zeo- | Gordes Inc | Clinoptillolite 50 um | | 2.4574 | 4.1113 | 6.3072 | 12.7478 | 37.3627 |
| Clinoptilolite 50 um | | | | | | | | |
| Sepiolite | [symbol] | Sepiolite | Sep [symbol] lite | 5.4218 | 6.9242 | 8.9977 | 11.3080 | 14.2650 |
| Na Bentonite | White Label Premium | [symbol] /AuO27 | Bentonite (Na) | 2.9311 | 3.8852 | 5.3790 | 7.5276 | 9.9464 |
| | Herbs and Spices | | | | | | | |
| Ca Bentonite | Health and Beauty | NA | Bentonite (Ca) | 3.4127 | 5.5816 | 8.6585 | 13.1871 | 21.5886 |
| | Aztec Secret | | | | | | | |
| CPM TiO2 | Zeolyst International | 1318-62-1 | ? | 148.6793 | 318.8738 | 512.7077 | 718.9686 | 918.4837 |
| OxPure 325A-9 | Bulk Supplements.com | [symbol] | Magnesium | 7.2275 | 3.8342 | 13.9729 | 21.1114 | 34.3000 |
| | | | Hydroxide | | | | | |
| CPM TiO2 (2) | CPM Industries | 13463-67-7 | Titanium Dioxide | 148.6793 | 318.8738 | 512.7077 | 718.9686 | 918.4837 |
| ST Cloud | St Cloud Mining | AZLB-Na-325 | Chabazite | 4.5775 | 7.5071 | 12.6369 | 23.1918 | 44.0193 |
| AzLB-NA | | | | | | | | |

[symbol]

indicates data missing or illegible when filed

Tables 2.1, 2.2 and 2.3 show a summaries of PLR(x), TLA(x,y), ALAₘᵢₓ, and S/Iₘᵢₓ for some combinations of lead sorbent materials listed in Table 1.2. Combinations shown in Table 2.1 show synergy (i.e., S/Iₘᵢₓ greater than about 5%). Table 2.2 shows results of combinations of sorbents with no synergistic or interfering effect (i.e., S/Iₘᵢₓ between about −5% and 5%). Table 2.3 shows results of combinations of sorbents that interfere (i.e., S/Iₘᵢₓ less than about −5%).

TABLE 2.1
Results of Lead Adsorption Tests for Combinations of Sorbents Exhibiting Synergy

| Mixture | PLR(A) | PLR(B) | TLAmix | ALAmix | S/I Mix |
|---|---|---|---|---|---|
| MgCo3 Se Alusil | 102.99% | 95.58% | 1.57% | 58.14% | 56.57% |
| Calcium Phosphate & CaCo3 | 92.03% | 98.95% | 8.94% | 63.33% | 54.39% |
| CaCo3 & ST. Cloud AZLB- Na | 99.70% | 68.36% | 31.83% | 81.03% | 49.18% |
| MgCo3 & Calcium Phosphate | 102.99% | 90.44% | 6.86% | 55.57% | 48.71% |
| MgCo3 & CaCo3 | 100.96% | 100.18% | −1.14% | 46.64% | 47.78% |
| CaCo3 & Zeoite B | 98.73% | 74.53% | 26.41% | 73.59% | 47.18% |
| CaCo3 & #7 Chabazite | 99.05% | 53.62% | 46.89% | 91.61% | 44.71% |
| MgCo3 & #7 Chabazite | 102.33% | 50.89% | 47.92% | 87.13% | 39.21% |
| #7 Chabazite & Alusil | 56.36% | 98.54% | 44.46% | 78.10% | 33.64% |
| CaCo3 & Alusil | 98.95% | 63.42% | 37.25% | 70.20% | 32.95% |
| Calcium Phosphate & #7 Chabazite | 89.96% | 53.62% | 51.77% | 83.61% | 31.85% |
| ATS & MgCo3 | 58.33% | 98.83% | 42.35% | 73.30% | 30.96% |
| ATS & Calcium Phosphate | 57.29% | 81.03% | 53.58% | 73.91% | 20.33% |
| ATS & CaCo3 | 57.29% | 76.28% | 56.30% | 74.93% | 18.64% |
| Calcium Phosphate & Bayoxide | 89.22% | 94.62% | 15.59% | 29.27% | 13.68% |
| ATS & Bayoxide | 58.33% | 93.65% | 45.37% | 57.47% | 12.10% |
| CaCo3 & Bayoxide | 97.30% | 92.09% | 10.40% | 20.38% | 9.98% |
| #7 Chabazite & Ca Bentonite | 59.66% | 91.32% | 45.52% | 54.88% | 9.36% |
| MgCo3 & Bayoxide | 100.00% | 92.09% | 7.91% | 16.24% | 8.33% |

TABLE 2.2
Results of Lead Adsorption Tests for Combinations of Sorbents Exhibiting No Synergy or Interference

| Mixture | PLR(A) | PLR(B) | TLAmix | ALAmix | S/I Mix |
|---|---|---|---|---|---|
| #7 Chabazite & Sepiolite | 53.95% | 97.45% | 47.43% | 51.48% | 4.05% |
| MgCo3 & Sepiolite | 101.38% | 98.19% | 0.46% | 3.19% | 2.73% |
| Bayoxide & #7 Chabazite | 94.91% | 53.85% | 48.89% | 51.23% | 2.34% |
| MgCo3 & #4 Coarse jw-em | 101.87% | 88.48% | 9.86% | 12.01% | 2.15% |
| CaCo3 & Sepiolite | 98.73% | 99.40% | 1.86% | 3.64% | 1.78% |
| Metsorb STPH & Fullers Earth Clay | 15.56% | 111.53% | 82.65% | 84.23% | 1.58% |
| CaCo3 & Ca Bentonite | 98.33% | 92.14% | 9.40% | 10.90% | 1.50% |
| Bayoxide & #4 Coarse jw-em | 94.48% | 86.73% | 18.06% | 19.28% | 1.22% |
| Bayoxide & Metsorb STPH | 98.58% | 16.49% | 83.75% | 83.31% | −0.43% |
| Metsorb STPH & MgCo3 | 15.56% | 100.80% | 84.32% | 83.69% | −0.62% |
| Metsorb STPH & Calcium Phosphate | 16.38% | 86.73% | 85.79% | 85.16% | −0.64% |
| Metsorb STPH & MgCo3 | 16.06% | 102.04% | 83.61% | 82.93% | −0.69% |
| Metsorb STPH & CaCo3 | 15.47% | 101.22% | 84.34% | 83.64% | −0.70% |
| Dina Aqua Alumina Selenium & #4 Coarse jw-em | 99.19% | 85.28% | 15.42% | 14.60% | −0.82% |
| #7 Chabazite & Zeoite B | 56.36% | 76.72% | 56.76% | 55.81% | −0.95% |
| #4 Coarse jw-em & Fullers Earth Clay | 86.74% | 92.28% | 19.96% | 18.21% | −1.75% |
| MgCo3 & Fullers Earth Clay | 99.52% | 92.35% | 8.09% | 6.14% | −1.95% |
| #4 Coarse jw-em & #7 Chabazite | 86.25% | 53.74% | 53.65% | 51.53% | −2.12% |
| Bayoxide & #5 Coarse Nv-Na | 94.48% | 23.95% | 77.37% | 75.26% | −2.12% |
| #5 Coarse Nv-Na & Fullers Earth Clay | 25.01% | 93.21% | 76.69% | 74.38% | −2.31% |
| MgCo3 & #5 Coarse Nv-Na | 101.87% | 24.04% | 75.51% | 73.13% | −2.38% |
| #5 Coarse Nv-Na & Na Bentonite | 25.01% | 79.79% | 80.05% | 77.65% | −2.40% |
| Calcium Phosphate & Metsorb STPH | 88.52% | 15.35% | 86.42% | 83.95% | −2.47% |
| #5 Coarse Nv-Na & Sepiolite | 25.35% | 98.20% | 75.11% | 72.49% | −2.62% |
| #4 Coarse jw-em & #5 Coarse Nv-Na | 86.74% | 25.59% | 77.80% | 74.99% | −2.81% |
| #4 Coarse jw-em & Na Bentonite | 84.54% | 75.98% | 35.77% | 32.57% | −3.20% |
| ATS & #4 Coarse jw-em | 59.41% | 81.68% | 51.48% | 48.26% | −3.22% |
| #4 Coarse jw-em & Sepiolite | 86.43% | 95.62% | 17.35% | 12.99% | −4.37% |
| CaCo3 & Fullers Earth Clay | 99.96% | 91.79% | 8.25% | 3.83% | −4.42% |
| #7 Chabazite & Fullers Earth Clay | 56.94% | 90.75% | 48.33% | 43.90% | −4.44% |
| #4 Coarse jw-em & Zeoite B | 84.83% | 72.72% | 38.31% | 33.83% | −4.48% |
| ATS & #7 Chabazite | 59.75% | 78.45% | 53.13% | 48.61% | −4.52% |

TABLE 2.3
Results of Lead Adsorption Tests for Combinations of Sorbents Exhibiting Interference

| Mixture | PLR(A) | PLR(B) | TLAmix | ALAmix | S/I Mix |
|---|---|---|---|---|---|
| Metsorb STPH & #4 Course jw-em | 15.45% | 66.99% | 89.65% | 84.50%% | −5.15% |
| #4 Coarse jw-em & Ca Bentonite | 84.54% | 89.72% | 24.15% | 18.87% | −5.28% |
| ATS & Metsorb STPH | 60.93% | 15.80% | 90.37% | 84.78% | −5.59% |
| #4 Coarse jw-em & Alusil | 84.83% | 95.98% | 18.58% | 12.54% | −6.04% |
| Calcium Phosphate & #4 Course jx-em | 89.65% | 87.12% | 21.89% | 15.57% | −6.33% |
| #5 Coarse Nv-Na & Zeoite B | 25.35% | 77.78% | 80.29% | 72.69% | −7.59% |
| #5 Coarse Nv-Na & Ca Bentonite | 25.13% | 90.58% | 77.24% | 69.63% | −7.61% |
| Metsorb STPH & #5 Coarse Nv-Na | 16.05% | 25.81% | 95.86% | 88.03% | −7.83% |
| ATS & #5 Coarse Nv-Na | 59.41% | 24.15% | 85.65% | 77.73% | −7.92% |
| CaCo3 & ST. Cloud NM-Ca | 98.95% | 85.50% | 15.40% | 7.35% | −8.05% |
| #5 Coarse Nv-Na & Metsorb STPH | 25.65% | 15.99% | 95.90% | 87.66% | −8.24% |
| Metsorb STPH & #7 Chabazite | 15.22% | 52.88% | 91.95% | 82.41% | −9.54% |
| #7 Chabazite & Na Bentonite | 39.66% | 77.19% | 53.95% | 43.56% | −10.39% |
| #7 Chabazite & #5 Course Nv-Na | 56.94% | 24.42% | 86.09% | 73.01% | −13.09% |
| CaCo3 & Nia Bentonite | 98.33% | 78.45% | 22.86% | 6.10% | −16.76% |
| MgCo3 & Ma Bentonite | 99.52% | 77.71% | 22.66% | 5.59% | −17.07% |
| CaCo3 & Gordes Zeolite | 99.96% | 60.39% | 39.63% | 21.11% | −18.52% |
| Calcium Phosphate & #3 Coarse Nv-Na | 92.03% | 26.24% | 75.85% | 56.42% | −19.43% |

The results shown in Tables 2.1, 2.2 and 2.3 are for combinations of lead sorbent material used in 50/50 ratio. Embodiments according to the disclosure are not limited to mixture with this ratio of materials. Materials that show a synergistic effect in a 50/50 mixture also show a synergistic when mixed in different proportions. However, the effect may not be as pronounced. To illustrate this, Calcium Carbonate and Chabazite #7, which showed synergy as discussed above, were tested in 50/50, 10/90 and 20/80 mixtures. Metsorb HMRP and Chabazite, which show interference as discussed above, were tested at 50/50, 10/90 and 20/80 mixtures. The results are shown in Table 3.1.

TABLE 3.1
Synergy/Interference for Mixtures at 10/90, 50/50, and 90/10 Ratios

| | | | | | | Expected | Actual | Percent |
|---|---|---|---|---|---|---|---|---|
| Material 1 | Material 2 | M1% | M2% | % Remaining M1 | % remaining M2 | Reduction | Reduction | Synergy |
| CaCO3 | #7 Chabazite | 0% | 100% | 100% | 27% | 73% | 73% | 0% |
| CaCO3 | #7 Chabazite | 10% | 90% | 100% | 32% | 68% | 74% | 6% |
| CaCO3 | #7 Chabazite | 20% | 80% | 99% | 37% | 64% | 80% | 16% |
| CaCO3 | #7 Chabazite | 50% | 50% | 95% | 50% | 53% | 89% | 37% |
| CaCO3 | #7 Chabazite | 80% | 20% | 96% | 80% | 23% | 74% | 51% |
| CaCO3 | #7 Chabazite | 90% | 10% | 93% | 88% | 18% | 58% | 40% |
| CaCO3 | #7 Chabazite | 100% | 0% | 90% | 100% | 10% | 10% | 0% |
| Mesorb HMRP | #7 Chabazite | 0% | 100% | 100% | 27% | 73% | 73% | 0% |
| Mesorb HMRP | #7 Chabazite | 10% | 90% | 89% | 30% | 74% | 72% | −2% |
| Mesorb HMRP | #7 Chabazite | 20% | 80% | 79% | 34% | 73% | 69% | −4% |
| Mesorb HMRP | #7 Chabazite | 50% | 50% | 42% | 53% | 78% | 60% | −18% |
| Mesorb HMRP | #7 Chabazite | 80% | 20% | 46% | 78% | 64% | 55% | −9% |
| Mesorb HMRP | #7 Chabazite | 90% | 10% | 42% | 89% | 63% | 57% | −6% |
| Mesorb HMRP | #7 Chabazite | 100% | 0% | 39% | 100% | 61% | 61% | 0% |

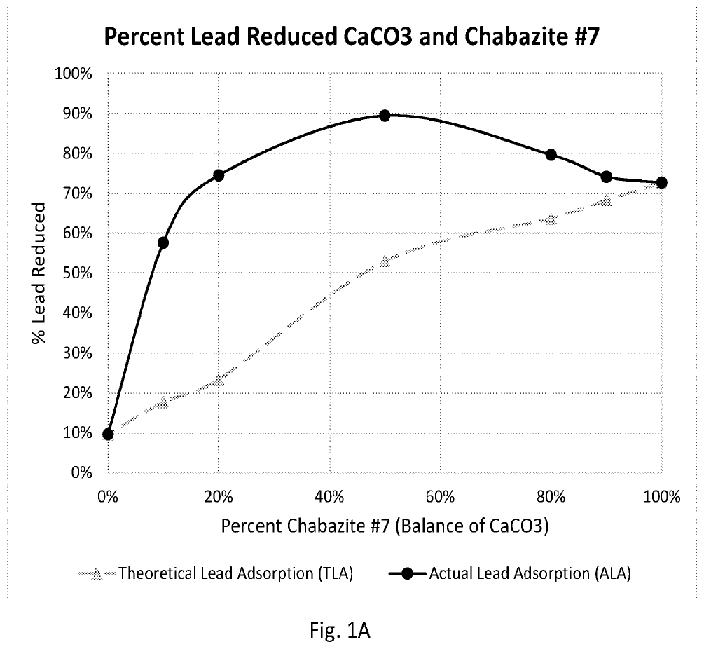

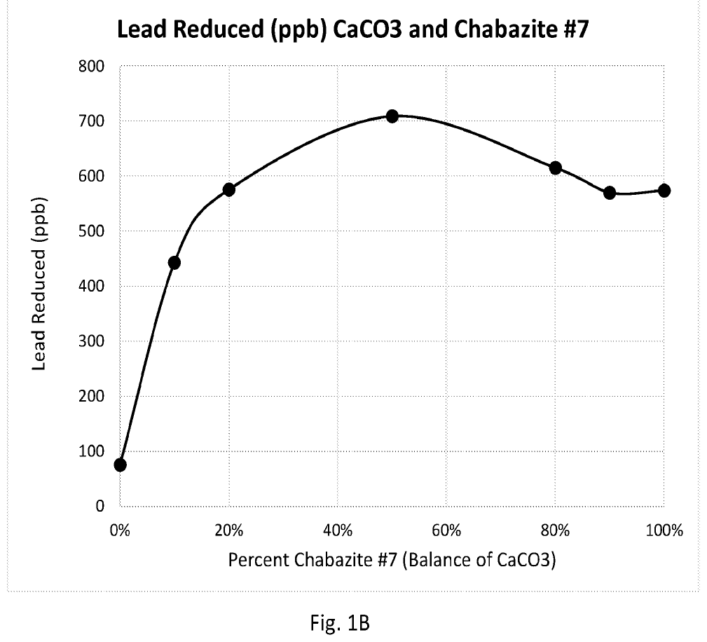

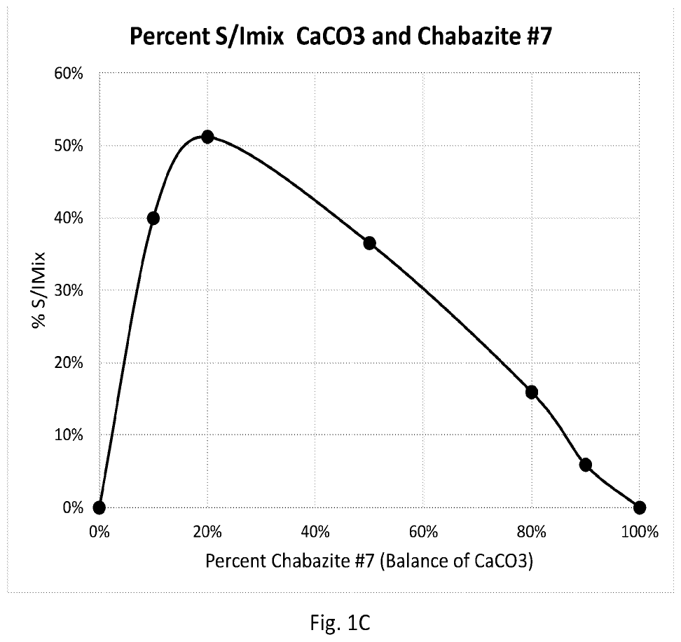

FIG. 1A is a graph showing lead reduction for mixtures of Calcium Carbonate and #7 Chabazite over a range of weight rations from about 0% Chabazite to about 100% Chabazite. The expected mix reduction, TLAₘᵢₓ, is lower than the actual mix reduction, ALAₘᵢₓ for the mixture across the range from about 10% Chabazite to about 90% Chabazite. FIG. 1B shows the actual lead reduction in ppb for combinations of #7 Chabazite and Calcium Carbonate across the same range of weight ratios. FIG. 1C shows the S/Iₘᵢₓ for combinations of these materials across the range of weight ratios. As can be seen in FIG. 1C, by selecting a weight ratio of about 20% Chabazite, a maximum synergy with Calcium Carbonate can be achieved. It is also shown by FIGS. 1A-1C, that for combinations of lead sorbents where a synergy is shown at a 50/50 ratio, as illustrated above, for example, in Table 2.1, synergy will also occur at weight ratios from about 10% chabazite to about 90% chabazite, as well as from about 20% chabazite to about 80% chabazite, as well as from about 30% chabazite to about 70% chabazite, as well as from about 40% chabazite to about 60% chabazite.

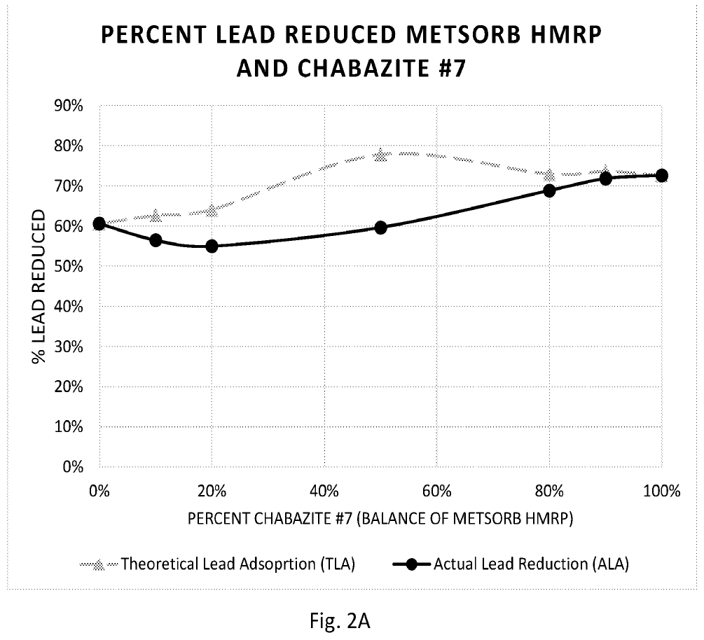

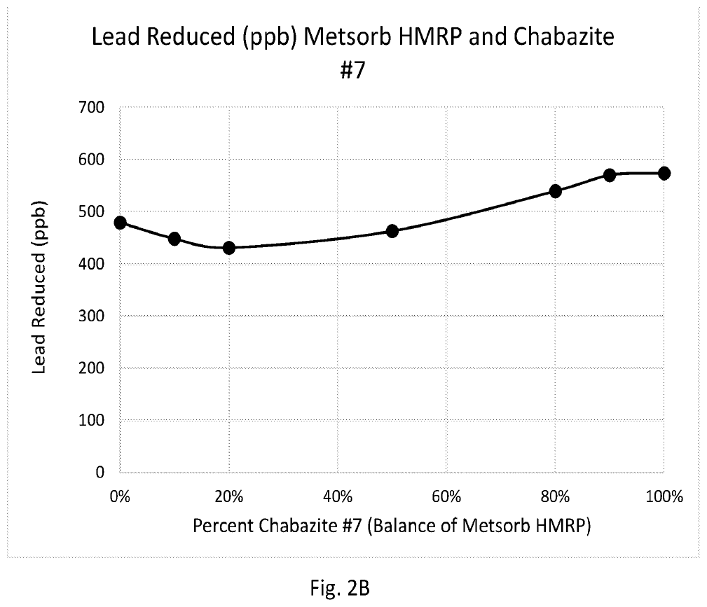

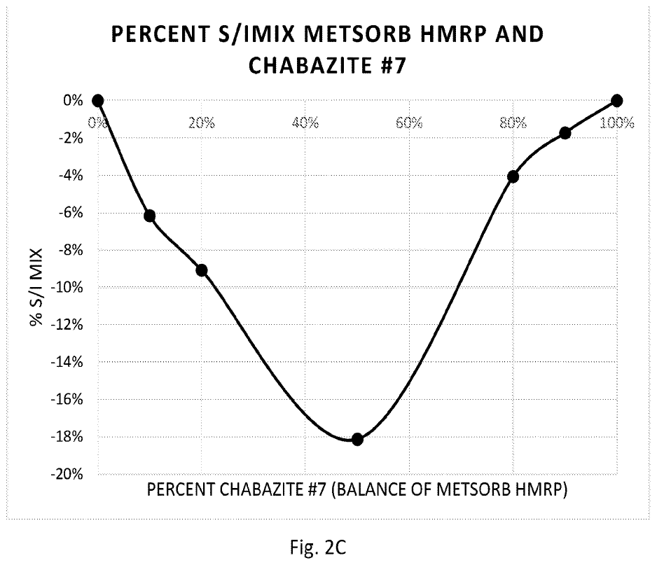

FIG. 2A is a graph showing lead reduction for mixtures of Metsorb HMRP and #7 Chabazite across a range of weight ratios from about 10% chabazite to about 100% chabazite. The expected mix reduction, TLAₘᵢₓ, is higher than the actual mix reduction, ALAₘᵢₓ for the mixture across the range from about 10% Chabazite to about 80% Chabazite. FIG. 2B shows the actual lead reduction in ppb for combinations of #7 Chabazite and Metsorb HMRP across the same range of weight ratios. FIG. 2C shows the S/Iₘᵢₓ for combinations of these materials across the range of weight ratios. As can be seen in FIG. 2C, by selecting a weight ratio of about 50% Chabazite, a maximum interference with Metsorb HMRP is found. It is also shown by FIGS. 2A-2C, that for combinations of lead sorbents where interference is shown at a 50/50 ratio, as illustrated above, for example, in Table 2.3, interference will also occur at weight ratios from about 10% chabazite to about 90% chabazite, as well as from about 20% chabazite to about 80% chabazite, as well as from about 30% chabazite to about 70% chabazite, as well as from about 40% chabazite to about 60% chabazite.

In addition to mixtures of lead sorbents where two lead sorbent components are provided, one or more additional lead sorbents can be provided in the mixture. For example, a mixture could be provided with two lead sorbents that exhibit synergy and the addition of a third lead sorbent that exhibits synergy with one or the other of the first two lead sorbents. In addition, other adjunct materials may be included in a mixture according to the disclosure along with lead sorbents. Such other materials can include materials that improve processing of the mixture. According to some embodiments, these process improving materials may include tricalcium phosphate, powdered cellulose, magnesium stearate, sodium bicarbonate, sodium ferrocyanide, potassium ferrocyanide, calcium ferrocyanide, bone phosphate (i.e. Calcium phosphate), sodium silicate, silicon dioxide, calcium silicate, magnesium trisilicate, ferric oxide, ferric hydroxide, ferric oxyhydroxide, talcum powder, sodium aluminosilicate, potassium aluminum silicate, calcium aluminosilicate, bentonite, aluminum silicate, stearic acid, polydimethylsiloxane, fumed silica, microcrystalline cellulose, and combinations thereof. According to one embodiment such process improving materials comprise up to 15% of the mixture. Other materials may include inert materials that provide bulk to the mixture or that maintain a porous structure to a filter element formed by the mixture. According to some embodiments where other adjunct materials are included in the mixture, the total quantity of combined lead sorbents in the overall mixture can be between about 10% and about 90% by weight of the overall mixture. According to other embodiments, the total quantity of lead adsorbents can be between about 20% and 80% of the overall mixture. According to other embodiments, the total quantity of lead adsorbents can be between about 30% and 70% of the overall mixture. According to other embodiments, the total quantity of lead adsorbents can be between about 40% and 60% of the overall mixture.

Combinations of lead absorbents that provide synergistic improvement in lead absorption can be identified by the elemental composition of the combined materials. Elemental composition was determined as follows using X-ray fluorescence. A beam of x-rays is applied to the material and the spectrum of energy emitted by the irradiated material is analyzed to determine the percentage by weight of particular elements in the material. Such a determination can be performed using commercially available devices. According to one embodiment, lead absorbing materials and mixtures of lead absorbing materials found to have synergistic or interfering effects were tested using a Vanta™ Series Handheld X-ray Fluorescence (XRF) Analyzer manufactured by Olympus Corp.

According to one embodiment of the disclosure, the concentration by weight of certain elemental components for combinations of materials shown to have synergistic or interfering activity in absorbing lead from water were determined. Each material was examined for elemental concentration individually. Based on the elemental composition of the individual materials, the overall elemental composition for combinations of materials were calculated. Mixtures of lead sorbent materials at a selected weight ratio is determined by multiplying the elemental composition of each by its weight percentage in the mixture and adding the compositions of the materials to find a total elemental composition.

Each material was analyzed individually as follows. Approximately 20 ml of the powdered material was placed in a stainless-steel puck mold. The mold was closed and placed in a reflex press. The press applied pressure on the mold to compress the powder into a solid puck. For some materials, the powder could not be compressed into a solid puck. In those instances, a plastic puck cartridge was filled with the powder and the cartridge was covered with an x-ray transparent film.

Each sample was examined by the x-ray fluorescence device. Three x-ray fluorescence measurements were taken for each sample, with the sample puck moved between measurements to reduce the effect of local variation in material composition at the surface of the sample on the measured elemental composition. The three measurements were averaged. The resulting elemental concentrations, by weight, were recorded for the materials discussed above. The elemental composition of mixtures of materials was determined by multiplying the elemental compositions of each material by the weight ratio of the material present in the mixture. This, for a 50/50 mixture of two materials, the elemental compositions of each material were multiplied by 0.5 and added together to find the total composition.

Table 4.1 shows combinations of lead sorbent materials and their respective S/Iₘᵢₓ metric for combinations for mixtures that exhibit synergy (i.e., and S/Iₘᵢₓ greater than about 5%).

TABLE 4.1
Elemental Compositions of Mixtures of Lead Sorbents with Synergistic Adsorption

| | | Mg | Al | Si | P | S | K | Ca | Ti | Fe | Sum of | |
|---|---|---|---|---|---|---|---|---|---|---|---|---|
| | | Concen- | Concen- | Concen- | Concen- | Concen- | Concen- | Concen- | Concen- | Concen- | Mg, Ca | Sum Ca |
| Mixture | S/I Mix | tration | tration | tration | tration | tration | tration | tration | tration | tration | and Fe | and Mg |
| MgCo3 & Alusil | 56.57% | 16.05% | 4.68% | 14.93% | 0.60% | 0.17% | 0.03% | 1.21% | 0.01% | 0.01% | 17.27% | 17.21% |
| Calcium Phosphate & | 54.39% | 0.00% | 0.07% | 0.67% | 0.38% | 0.00% | 0.03% | 38.16% | 0.04% | 0.15% | 38.31% | 38.31% |
| CaCo3 | | | | | | | | | | | | |
| CaCo3 & ST. Cloud | 49.18% | 0.24% | 3.95% | 13.75% | 0.00% | 0.70% | 0.34% | 22.19% | 0.05% | 1.21% | 23.64% | 23.64% |
| AZLB-Na | | | | | | | | | | | | |
| MgCo3 & Calcium | 48.71% | 15.24% | 0.11% | 0.61% | 6.38% | 0.16% | 0.01% | 16.41% | 0.01% | 0.13% | 32.48% | 32.48% |
| Phosphate | | | | | | | | | | | | |
| MgCo3 & CaCo3 | 47.78% | 15.94% | 0.04% | 0.19% | 0.00% | 0.16% | 0.03% | 21.59% | 0.02% | 0.03% | 37.35% | 37.35% |
| CaCo3 & Zeolite B | 47.18% | 0.17% | 4.50% | 12.95% | 0.00% | 0.00% | 2.41% | 23.53% | 0.14% | 1.48% | 25.19% | 25.19% |
| CaCo3 & #7 Chabazite | 44.71% | 0.00% | 4.01% | 13.14% | 0.01% | 0.55% | 0.32% | 21.97% | 0.05% | 1.28% | 23.25% | 23.25% |
| MgCo3 & #7 Chabazite | 30.21% | 15.94% | 4.05% | 13.08% | 0.01% | 0.75% | 0.30% | 0.23% | 0.03% | 1.25% | 17.42% | 17.42% |
| #7 Chabazite & Alusil | 33.64% | 0.11% | 8.65% | 27.88% | 0.01% | 0.56% | 0.38% | 1.29% | 0.04% | 1.26% | 2.66% | 2.66% |
| CaCo3 & Alusil | 32.95% | 0.11% | 4.64% | 14.99% | 0.60% | 0.00% | 0.11% | 22.95% | 0.03% | 0.03% | 23.10% | 23.10% |
| Calcium Phosphate & | 31.65% | 0.00% | 4.03% | 13.56% | 6.39% | 0.55% | 0.30% | 16.30% | 0.04% | 1.38% | 17.88% | 17.88% |
| #7 Chabazite | | | | | | | | | | | | |
| ATS & MgCo3 | 30.96% | 15.94% | 0.04% | 7.34% | 0.00% | 0.16% | 0.00% | 0.07% | 11.86% | 0.01% | 16.02% | 16.02% |
| ATS & Calcium | 20.33% | 0.00% | 0.07% | 7.82% | 6.38% | 0.00% | 0.00% | 16.34% | 11.82% | 0.13% | 16.47% | 16.47% |
| Phosphate | | | | | | | | | | | | |
| ATS & CaCo3 | 13.64% | 0.00% | 0.00% | 7.40% | 0.00% | 0.00% | 0.02% | 21.32% | 11.35% | 0.03% | 21.85% | 21.85% |
| Calcium Phosphate & | 13.63% | 0.75% | 0.42% | 0.60% | 6.39% | 0.09% | 0.00% | 16.36% | 0.01% | 30.24% | 47.35% | 47.35% |
| Bayoxide | | | | | | | | | | | | |
| ATS & Bayoxide | 12.10% | 0.75% | 0.35% | 7.33% | 0.01% | 0.09% | 0.00% | 0.12% | 11.86% | 30.02% | 30.88% | 30.88% |
| CaCo3 & Bayoxide | 9.98% | 0.75% | 0.35% | 0.18% | 0.01% | 0.09% | 0.02% | 21.94% | 0.02% | 30.04% | 32.72% | 32.72% |
| #7 Chabazite & Ca | 9.36% | 4.06% | 6.00% | 23.94% | 0.03% | 0.36% | 1.64% | 0.63% | 0.12% | 2.34% | 110.04% | 10.04% |
| Bentonite | | | | | | | | | | | | |
| MgCo3 & Bayoxide | 8.33% | 16.68% | 0.38% | 0.12% | 0.01% | 0.25% | 0.00% | 0.19% | 0.00% | 30.01% | 46.89% | 46.89% |

As shown in Table 4.1, combinations of lead sorbents that exhibit synergy have elemental concentrations with certain characteristics. For each of these combinations the total percent of divalent ions (that is, having a +2 valence when dissolved in water), for example, magnesium, calcium, and iron, is greater than about 2% by weight. These combinations have a total percent of silicone less than about 32% by weight. In particular, these combinations have a total percent of magnesium and calcium of greater than about 3.5% by weight and a total percent of silicone less than about 22% by weight.

Table 4.2 shows combinations of lead sorbent materials and their respective S/Iₘᵢₓ metric for combinations for mixtures that exhibit no synergy or interference (i.e., and S/Iₘᵢₓ less than about 5% and greater than about −5%).

TABLE 4.2
Elemental Compositions of Mixtures of Lead Sorbents with No Synergistic or Interfering Adsorption

| | | Mg | Al | Si | P | S | K | Ca | Ti | Fe | Sum of | |
|---|---|---|---|---|---|---|---|---|---|---|---|---|
| | | Concen- | Concen- | Concen- | Concen- | Concen- | Concen- | Concen- | Concen- | Concen- | Mg, Ca | Sum Ca |
| Mixture | S/I Mix | tration | tration | tration | tration | tration | tration | tration | tration | tration | and Fe | and Mg |
| #7 Chabazite & Sepiolite | 4.05% | 7.93% | 4.92% | 27.78% | 0.02% | 0.56% | 0.46% | 0.98% | 0.08% | 2.21% | 11.13% | 11.13% |
| MgCo3 & Sepiolite | 2.73% | 23.87% | 0.95% | 14.83% | 0.02% | 0.17% | 0.16% | 0.90% | 0.06% | 0.96% | 25.73% | 25.73% |
| Bayoxide & #7 Chabazite | 2.34% | 0.75% | 4.36% | 13.07% | 0.02% | 0.64% | 0.30% | 0.28% | 0.03% | 31.26% | 32.29% | 32.29% |
| MgCo3 & #4 Coarse jw-em | 2.15% | 16.24% | 3.48% | 17.21% | 0.01% | 0.16% | 1.53% | 1.05% | 0.06% | 0.48% | 17.78% | 17.78% |
| CaCo3 & Sepiolite | 1.78% | 7.93% | 0.91% | 14.89% | 0.01% | 0.01% | 0.18% | 22.64% | 0.08% | 0.98% | 31.56% | 31.56% |
| Metsorb STPH & Fullers | 1.58% | 2.10% | 3.22% | 19.85% | 0.16% | 0.50% | 0.36% | 0.58% | 14.81% | 1.74% | 4.42% | 4.42% |
| Earth Clay | | | | | | | | | | | | |
| CaCo3 & Ca Bentonite | 1.50% | 4.06% | 1.99% | 11.06% | 0.02% | 0.01% | 1.37% | 25.29% | 0.11% | 1.12% | 30.47% | 30.47% |
| Bayoxide & #4 Coarse jw-em | 1.22% | 1.05% | 3.79% | 17.20% | 0.02% | 0.09% | 1.52% | 1.10% | 0.06% | 30.49% | 32.65% | 32.65% |
| Bayoxide & Metsorb STPH | −0.43% | 0.75% | 0.35% | 5.41% | 0.01% | 0.59% | 0.00% | 0.17% | 14.67% | 30.02% | 30.93% | 30.93% |
| Metsorb STPH & MgCo3 | −0.62% | 15.94% | 0.04% | 5.42% | 0.00% | 0.66% | 0.00% | 0.12% | 14.67% | 0.01% | 16.06% | 16.06% |
| Metsorb STPH & Calcium | −0.64% | 0.00% | 0.07% | 5.90% | 6.38% | 0.50% | 0.00% | 16.39% | 14.68% | 0.13% | 16.52% | 16.52% |
| Phosphate | | | | | | | | | | | | |
| Metsorb STPH & MgCo3 | −0.69% | 15.94% | 0.04% | 5.42% | 0.00% | 0.66% | 0.00% | 0.12% | 14.67% | 0.01% | 16.06% | 16.06% |
| Metsorb STPH & CaCo3 | −0.70% | 0.00% | 0.00% | 5.48% | 0.00% | 0.50% | 0.02% | 21.86% | 14.69% | 0.03% | 21.90% | 21.90% |
| Dina Aqua Alumina | −0.82% | 0.31% | 25.97% | 17.15% | 0.01% | 0.01% | 1.52% | 0.98% | 0.07% | 0.49% | 1.78% | 1.78% |
| Selenium & #4 Coarse jw-em | | | | | | | | | | | | |
| #7 Chabazite & Zeoite B | −0.95% | 0.17% | 8.51% | 25.84% | 0.07% | 0.55% | 2.69% | 1.87% | 0.14% | 2.71% | 4.76% | 4.76% |
| #4 Coarse jw-em & | −1.75% | 2.41% | 6.67% | 31.64% | 0.17% | 0.00% | 1.88% | 1.51% | 0.20% | 2.22% | 6.13% | 6.13% |
| Fullers Earth Clay | | | | | | | | | | | | |
| MgCo3 & Fullers Earth Clay | −1.95% | 18.04% | 3.26% | 14.56% | 0.16% | 0.16% | 0.37% | 0.60% | 0.14% | 1.73% | 20.38% | 20.38% |
| #4 Coarse jw-em & #7 Chabazite | −2.12% | 0.31% | 7.45% | 30.16% | 0.02% | 0.55% | 1.82% | 1.13% | 0.09% | 1.74% | 3.18% | 3.18% |
| Bayoxide & #5 Coarse Nv-Na | −2.12% | 0.85% | 3.39% | 16.81% | 0.01% | 0.09% | 1.60% | 0.43% | 0.03% | 30.33% | 31.61% | 31.61% |
| #5 Coarse Nv-Na & Fullers | −2.31% | 2.21% | 6.26% | 31.25% | 0.16% | 0.01% | 1.96% | 0.84% | 0.16% | 2.05% | 5.09% | 5.09% |
| Earth Clay | | | | | | | | | | | | |
| MgCo3 & #5 Coarse Nv-Na | −2.38% | 16.04% | 3.08% | 16.82% | 0.00% | 0.17% | 1.60% | 0.37% | 0.03% | 0.32% | 16.74% | 16.74% |
| #5 Coarse Nv-Na & Na | −2.40% | 0.75% | 7.58% | 31.04% | 0.00% | 0.09% | 1.76% | 0.75% | 0.07% | 1.88% | 3.39% | 3.39% |
| Bentonite | | | | | | | | | | | | |
| Calcium Phosphate & Metsorb | −2.47% | 0.00% | 0.07% | 5.90% | 6.38% | 0.50% | 0.00% | 16.39% | 14.68% | 0.13% | 16.52% | 16.52% |
| STPH | | | | | | | | | | | | |
| #5 Coarse Nv-Na & Sepiolite | −2.62% | 8.04% | 3.95% | 31.52% | 0.01% | 0.01% | 1.76% | 1.13% | 0.08% | 1.28% | 10.44% | 10.44% |
| #4 Coarse jw-em & #5 Coarse | −2.81% | 0.41% | 6.48% | 33.90% | 0.01% | 0.01% | 3.12% | 1.28% | 0.09% | 0.80% | 2.49% | 2.49% |
| Nv-Na | | | | | | | | | | | | |
| #4 Coarse jw-em & Na | −3.20% | 0.96% | 7.98% | 31.43% | 0.01% | 0.09% | 1.68% | 1.43% | 0.11% | 2.05% | 4.43% | 4.43% |
| Bentonite | | | | | | | | | | | | |
| ATS & #4 Coarse jw-em | −3.22% | 0.31% | 3.44% | 24.42% | 0.01% | 0.00% | 1.52% | 0.98% | 11.92% | 0.49% | 1.77% | 1.77% |
| #4 Coarse jw-em & Sepiolite | −4.37% | 8.24% | 4.36% | 31.91% | 0.03% | 0.01% | 1.68% | 1.80% | 0.12% | 1.44% | 11.48% | 11.48% |
| CaCo3 & Fullers Earth Clay | −4.42% | 2.10% | 3.22% | 14.62% | 0.16% | 0.00% | 0.39% | 22.35% | 0.16% | 1.76% | 26.21% | 26.21% |
| #7 Chabazite & Fullers | −4.44% | 2.10% | 7.23% | 27.51% | 0.17% | 0.55% | 0.66% | 0.69% | 0.16% | 2.99% | 5.78% | 5.78% |
| Earth Clay | | | | | | | | | | | | |
| #4 Coarse jw-em & Zeoite B | −4.48% | 0.48% | 7.94% | 29.97% | 0.07% | 0.00% | 3.91% | 2.69% | 0.18% | 1.94% | 5.12% | 5.12% |
| ATS & #7 Chabazite | −4.52% | 0.00% | 4.01% | 20.29% | 0.01% | 0.55% | 0.30% | 0.16% | 11.88% | 1.26% | 1.41% | 1.41% |

Table 4.3 shows combinations of lead sorbent materials and their respective S/Iₘᵢₓ metric for combinations for mixtures that exhibit interference (i.e., S/Iₘᵢₓ less than about −5%).

TABLE 4.3
Elemental Compositions of Mixtures of Lead Sorbents with Interfering Adsorption

| | | Mg | Al | Si | P | S | K | Ca | Ti | Fe | Sum of | |
|---|---|---|---|---|---|---|---|---|---|---|---|---|
| | | Concen- | Concen- | Concen- | Concen- | Concen- | Concen- | Concen- | Concen- | Concen- | Mg, Ca | Sum Ca |
| Mixture | S/I Mix | tration | tration | tration | tration | tration | tration | tration | tration | tration | and Fe | and Mg |
| Metsorb STPH & #4 | −5.15% | 0.31% | 3.44% | 22.50% | 0.01% | 0.50% | 1.52% | 1.02% | 14.72% | 0.49% | 1.82% | 1.82% |
| Coarse jw-em | | | | | | | | | | | | |
| #4 Coarse jw-em & Ca | −5.28% | 4.37% | 3.44% | 28.08% | 0.03% | 0.01% | 2.87% | [symbol] 45% | 0.15% | 1.57% | 10.39% | 10.39% |
| Bentonite | | | | | | | | | | | | |
| ATS & Metsorb STPH | −5.59% | 0.00% | 0.00% | 12.63% | 0.00% | 0.50% | 0.00% | 0.05% | 26.53% | 0.01% | 0.06% | 0.06% |
| #4 Coarse jw-em & Alusil | −6.04% | 0.41% | 8.08% | 32.01% | 0.01% | 0.00% | 1.60% | 2.11% | 0.07% | 0.49% | 3.02% | 3.02% |
| Calcium Phosphate & #4 | −6.33% | 0.31% | 3.51% | 17.69% | 6.39% | 0.00% | 1.33% | 17.32% | 0.08% | 0.61% | 18.23% | 18.23% |
| Coarse jw-em | | | | | | | | | | | | |
| #5 Coarse Nv-Na & Zeoite B | −7.59% | 0.28% | 7.54% | 29.58% | 0.06% | 0.01% | 3.99% | 2.02% | 0.14% | 1.78% | 4.08% | 4.08% |
| #5 Coarse Nv-Na & Ca | −7.61% | 4.17% | 5.03% | 27.69% | 0.02% | 0.01% | 2.94% | 3.77% | 0.11% | 1.41% | 9.35% | 9.35% |
| Bentonite | | | | | | | | | | | | |
| Metsorb STPH & #5 | −7.85% | 0.10% | 3.04% | 22.11% | 0.00% | 0.50% | 1.60% | 0.35% | 14.69% | 0.33% | 0.78% | 0.78% |
| Coarse Nv-Na | | | | | | | | | | | | |
| ATS & #5 Coarse Nv-Na | −7.92% | 0.10% | 3.04% | 24.63% | 0.00% | 0.01% | 1.60% | 0.30% | 11.88% | 0.32% | 0.73% | 0.73% |
| CaCo3 & ST Cloud NM-Ca | −8.05% | 0.45% | 3.49% | 16.92% | 0.01% | 0.00% | 1.17% | 22.93% | 0.09% | 0.70% | 24.10% | 24.10% |
| #5 Coarse Nv-Na & | −8.24% | 0.10% | 3.04% | 22.11% | 0.00% | 0.50% | 1.60% | 0.35% | 14.69% | 0.33% | 0.78% | 0.78% |
| Metsorb STPH | | | | | | | | | | | | |
| Metsorb STPH & #7 | −9.54% | 0.00% | 4.01% | 15.37% | 0.01% | 1.05% | 0.30% | 0.20% | 14.20% | 1.26% | 1.46% | 1.46% |
| Chabazite | | | | | | | | | | | | |
| #7 Chabazite & Na | −10.30% | 0.65% | 8.33% | 27.30% | 0.01% | 0.64% | 0.46% | 0.61% | 0.07% | 2.82% | 4.07% | 4.07% |
| Bentonite | | | | | | | | | | | | |
| #7 Chabazite & #5 | −13.09% | 0.10% | 7.05% | 29.77% | 0.01% | 0.36% | 1.00% | 0.46% | 0.05% | 1.57% | 2.14% | 2.14% |
| Coarse Nv-Na | | | | | | | | | | | | |
| CaCo3 & Na Bentonite | −16.76% | 0.65% | 4.34% | 14.42% | 0.00% | 0.09% | 0.19% | 22.27% | 0.07% | 1.39% | 24.50% | 24.50% |
| MgCo3 & Na Bentonite | −17.07% | 16.09% | 4.57% | 14.36% | 0.01% | 0.25% | 0.17% | 0.52% | 0.04% | 1.36% | 18.67% | 18.67% |
| CaCo3 & Gordes Zeolite | −18.52% | 0.30% | 3.26% | 17.64% | 0.00% | 0.03% | 1.33% | 22.81% | 0.06% | 0.64% | 23.75% | 23.75% |
| Calcium Phosphate & #5 | −19.43% | 0.10% | 3.11% | 17.30% | 6.38% | 0.01% | 1.60% | 16.64% | 0.04% | 0.44% | 17.19% | 17.19% |
| Coarse Nv-Na | | | | | | | | | | | | |

[symbol]

indicates data missing or illegible when filed

As discussed above, many commercial lead sorbents use titanium compounds to remove lead from water. Such compounds are relatively expensive compared with sorbents that do not include titanium. The amount of relatively expensive titanium compounds needed to achieve the same lead absorbance may be reduced by combining a titanium containing sorbent with another non-titanium sorbent that exhibits synergistic effects to sequester lead according to embodiments of the disclosure. For example, ATS, which includes titanium silicates is effective at removing lead from water. ATS is relatively expensive compared with other compounds that do not contain substantial amounts of titanium, such as magnesium carbonate (MgCO₃), calcium phosphate (Ca₃(PO₄)₂), ferric oxyhydroxide (FeHO₂) (e.g. Bayoxide), or calcium carbonate (CaCO₃). As shown in Table 2.1, the non-titanium based sorbents exhibit a significant synergistic effect when combined with ATS. As a result, for a given quantity of ATS, combining that sorbent with one or more of these non-titanium-based lead sorbents results in an improvement in lead adsorption as compared to ATS alone, while potentially reducing the amount of the expensive, titanium-based compound. By adjusting relative quantities of combinations of sorbents, a selected efficacy for removing lead from water based on filer characteristics that alter contact time, for example, filter geometry, flow volume, face velocity can be selected. Such a combination may be more cost-effective than using a single lead sorbent alone.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

1. A powdered lead adsorbent mixture comprising:
a first lead sorbent material at a first proportion of the mixture; and
a second lead sorbent material at a second proportion of the mixture,
wherein the mixture has a D50 particle size less than 100 microns, and wherein the mixture exhibits an S/Iₘᵢₓ metric greater than 5%.

2. The powdered lead adsorbent mixture of claim 1, wherein the first lead sorbent is selected from calcium carbonate, magnesium carbonate, calcium phosphate, ATS, and Metsorb.

3. The powdered lead adsorbent mixture of claim 1, wherein the second lead sorbent is a zeolite.

4. The powdered lead adsorbent mixture of claim 1, wherein the mixture has an elemental composition comprising
a percentage of divalent ions greater than or equal to about 2% by weight; and
a percentage of silicone less than or equal to about 32% by weight,
wherein the elemental composition is determined by x-ray fluorescence measurements of the first lead sorbent material and the second lead sorbent material.

5. The powdered lead adsorbent mixture of claim 4, wherein the divalent ions are ions of calcium and magnesium and wherein the elemental composition comprises:
a percentage of divalent ions greater than or equal to about 3.5% by weight; and
a percentage of silicone less than or equal to about 22% by weight

6. The powdered lead adsorbent mixture of claim 3, wherein the zeolite is chabazite or clinoptilolite.

7. The powdered lead adsorbent mixture of claim 1, wherein the first and second lead sorbent materials comprise zeolites, molecular sieves, heavy metal scavengers, metal oxides, metal hydroxides, metal oxyhydroxides, metal phosphates, metal silicates, and metal carbonates.

8. The powdered lead adsorbent mixture of claim 1, further comprising a third lead sorbent material.

9. The powdered lead adsorbent mixture of claim 1, wherein the first portion is greater than or equal to 10% by weight of the mixture and the second portion is less than or equal to 90% by weight of the mixture.

10. The powdered lead adsorbent mixture of claim 9, wherein the first portion is greater than or equal to 20% by weight of the mixture and the second portion is less than or equal to 80% by weight of the mixture.

11. The powdered lead adsorbent mixture of claim 9, wherein the first and second portions are about 50% by weight of the mixture.

12. The powdered lead adsorbent mixture of claim 1, further comprising an adjunct material.

13. The powdered lead adsorbent mixture of claim 12, wherein the adjunct material is a process improving material selected from tricalcium phosphate, powdered cellulose, magnesium stearate, sodium bicarbonate, sodium ferrocyanide, potassium ferrocyanide, calcium ferrocyanide, bone phosphate (i.e. calcium phosphate), sodium silicate, silicon dioxide, calcium silicate, magnesium trisilicate, metal oxide, metal hydroxide, metal oxyhydroxide, talcum powder, sodium aluminosilicate, potassium aluminum silicate, calcium aluminosilicate, bentonite, aluminum silicate, stearic acid, polydimethylsiloxane, fumed silica, microcrystalline cellulose, and combinations thereof.

14. The powdered lead adsorbent mixture of claim 13, wherein the process improving material comprises less than about 15% by weight of the mixture.

15. The powdered lead adsorbent mixture of claim 13, wherein the process improving material is a metal oxide, metal hydroxide, or metal oxyhydroxide and forms up to about 15% by weight of the mixture.

16. The powdered lead adsorbent mixture of claim 1, wherein the first lead sorbent comprises titanium and wherein the second lead sorbent is substantially free of titanium.

17. The powdered lead adsorbent mixture of claim 16, wherein the first lead sorbent comprises ATS.

18. The powdered lead adsorbent of claim 16, wherein the second lead sorbent comprises one of more of magnesium carbonate, calcium phosphate, ferric oxyhydroxide, and calcium carbonate.
